(19) United States
(12) Patent Application Publication
(10) Pub. No.: US 2003/0205932 A1
(43) Pub. Date: Nov. 6, 2003

(54) Master cylinder for an electro-hydraulic braking system comprising improved means of simulating the pedal feel and an electro-hydraulic braking system comprising such a master cylinder

(76) Inventor: Chris Anderson, Paris (FR)

Correspondence Address: Leo H. McCormick Jr., 2112 Mishawaka Avenue, P.O. Box 4721, South Bend, IN, 46634, US

(21) Appl. No.: 10/373,467

(22) Filed: Feb. 24, 2003

(30) Foreign Application Priority Data
Feb. 25, 2002 (FR) 02/02449

(51) Int. Cl. B60T 8/66

(52) U.S. Cl. 303/114.1

(57) ABSTRACT

Elastic return means comprising a spiral spring with turns (3) equipped at a first end with a fixing base, the base (9) is elastic radially so as to be capable of engaging through elasticity in an accommodating cavity formed in at least one wall (10) of an elongate part (29), characterized in that the base (9) is of polygonal shape and in that the base (9) winds in the opposite direction to the spiral formed by the turns (3).

The main subject of the present invention is a master cylinder for electro-hydraulic braking systems comprising a body pierced with a bore, a piston mounted to slide in sealed fashion in the bore and axially dividing the bore into a supply chamber sealedly connected to a brake fluid reservoir and a working chamber and a cartridge simulating the pedal feel, the said working chamber in normal operation being in communication with the inside of the cartridge simulating the pedal feel and in degraded operation being in communication with at least one brake arranged at a wheel, the said cartridge comprising a piston able to be subjected, via a first face to the pressurized brake fluid supplied by the working chamber and subjected via a second face to a variable-stiffness elastic means, characterized in that the elastic means comprises at least a first helical spring and a second helical spring, the first spring having first turns and being mounted so as to bear between the second face of the piston of the cartridge and an end wall of the cartridge, the second spring having second turns and being mounted coaxial with the first spring so that the elastic means comprises sets formed of a driving turn Ste of the first spring and of a driven turn of the second spring, the driving turn preceding the driven turn of the same set in the direction of travel of the piston of the cartridge under a braking action, and in that the driven turn of a set is able to form a mobile bearing means for the driving turn of the said set under a braking action.

The present invention relates mainly to a master cylinder for an electro-hydraulic braking system comprising improved means of simulating the pedal feel and to an electro-hydraulic braking system comprising such a master cylinder.

Electro-hydraulic braking systems comprise a master cylinder which, in normal operation, simulates the mechanical reaction of a conventional braking circuit felt at the brake pedal by a driver, and means for detecting the action of the driver on the brake pedal, the detection means sending the information to a computer which generates the command to a hydraulic pump to send pressurized brake fluid to the brakes. In degraded operation, for example when the pump does not respond, the master cylinder supplies pressurized brake fluid to the brakes like in a conventional braking circuit.

Master cylinders for electro-hydraulic braking systems of known type comprise a body of substantially cylindrical shape in which there is made a bore divided into at least one feed chamber and one working chamber by a piston mounted to slide in a sealed manner in the bore and actuated by an actuating rod connected to a brake pedal. The piston at rest allows communication between the two chambers and sealedly separates the two chambers during a braking action. The supply chamber is connected in a sealed manner to a brake fluid reservoir and the working chamber in normal operation is connected to a cartridge simulating the pedal feel or pedal feel cartridge and in degraded operation is connected to at least one brake arranged at a wheel.

The pedal feel cartridge comprises an envelope delimiting a substantially cylindrical chamber in which there slides a piston subjected, in normal operation, during a braking phase, via a first face, to the pressurized brake fluid supplied by the working chamber and via a second face to a first end of an elastic means, the second end of the elastic means bearing against the closed end of the chamber that is opposite the piston. The elastic means makes it possible to simulate the mechanical reaction of a conventional braking circuit, which corresponds to a relationship connecting the force at the pedal as a function of the pedal travel. The characteristic curve of this relationship has at least one first part corresponding to the absorption of the braking circuit at the beginning of the braking phase, then a second part corresponding to a reaction which increases in magnitude as the level of braking increases. The elastic means of known type for pedal feel cartridges are therefore very complicated and expensive; for example, they contain several helical springs, with different spring rates, with constant pitch, variable pitch, elastomer elements to simulate the absorption of the circuit. In addition, assembly is lengthy and therefore increases the cost price because of the high number of components needed to correctly simulate a conventional pedal reaction.

Electro-hydraulic braking systems provide excellent control over the braking and the vehicle, although the means simulating the reaction of the braking circuit are relatively complicated and require precise adjustment, consequently making it inconceivable to apply them to a wide range of vehicles.

In addition, motor vehicle manufacturers are wanting to standardize, as far as possible, the components that make up the braking systems. However, each type of motor vehicle has a characteristic pedal feel, which currently entails making significant modifications to the pedal feel simulation means to suit each type of motor vehicle.

It will be particularly advantageous for the driver of the vehicle to be able to modify the pedal feel according to the desired type of driving, something which is currently impossible with the existing means. In particular, when the motor vehicle is driven by several people who all have different braking preferences, it would be possible for the vehicle computer to store the settings of the pedal feel device relating to each person likely to use the motor vehicle, and to carry out automatic setting-up once the driver has been identified.

It is conceivable to reduce the number of parts of which the simulation cartridge is formed, for example using just one spring.

The use of springs of the helical type with uniform pitch is unsuitable because these springs have a constant spring rate k, and the deformation force Fd is connected as a linear relationship to the axial deformation x by the relationship Fd=k*x, this relationship being valid as long as the spring deformation is elastic.

There are also variable-pitch springs the deformation force of which is a non-linear function of the axial deformation of the spring and the characteristic of which is more similar to that of a conventional braking circuit, although these springs do not allow adjustment of the simulated pedal feel to suit the type of vehicle and/or the driver.

Thus one object of the present invention is to offer a master cylinder for an electro-hydraulic braking system that is of simple design and allows a simulated pedal feel very similar to the reaction of a conventional braking circuit.

Another object of the present invention is to offer a master cylinder for an electro-hydraulic braking system, that can easily be applied to various models of motor vehicle.

Another object of the present invention is to offer a master cylinder for an electro-hydraulic braking system, the simulated pedal feel of which can be adjusted in a simple way.

Another object of the present invention is to offer a master cylinder for an alectro-hydraulic braking system, that can be used for several models of motor vehicle.

These objects are achieved by a master cylinder comprising a cartridge simulating the pedal feel comprising an elastic means reproducing the reaction of a conventional braking circuit, the elastic means comprising a first helical spring and mobile bearing means for at least one turn of the first helical spring and allowing the stiffness of the elastic means to be modified at least once.

In other words, the elastic means comprises a first and a second helical spring which are coaxial, the turns of the second spring being arranged in the spaces separating the turns of the first spring, the turns of the first spring which, during the movement of the piston, move closer to one another and come to bear against the turns of the second spring which are then themselves moved in the direction of travel of the piston, causing an increase in the stiffness of the elastic means according to the present invention, which increase in stiffness is substantially continuous, simulating the reaction at the brake pedal in a conventional braking circuit.

In addition, as the change in stiffness is dependent upon the distances separating a turn of the first spring from a turn of the second spring with which it is likely to come into contact, it is then advantageously possible to conceive of a device that allows these distances to be modified and thus the pedal feel characteristic to be varied in a simple way.

The main subject of the present invention is a master cylinder for electro-hydraulic braking systems comprising a body pierced with a bore, a piston mounted to slide in sealed fashion in the bore and axially dividing the bore into a supply chamber sealedly connected to a brake fluid reservoir and a working chamber and a cartridge simulating the pedal feel, the said working chamber in normal operation being in communication with the inside of the cartridge simulating the pedal feel and in degraded operation being in communication with at least one brake arranged at a wheel, the said cartridge comprising a piston able to be subjected, via a first face to the pressurized brake fluid supplied by the working chamber and subjected via a second face to a variable-stiffness elastic means, characterized in that the elastic means comprises at least a first helical spring and a second helical spring, the first spring having first turns and being mounted so as to bear between the second face of the piston of the cartridge and an end wall of the cartridge, the second spring having second turns and being mounted coaxial with the first spring so that the elastic means comprises sets formed of a driving turn Ste of the first spring and of a driven turn of the second spring, the driving turn preceding the driven turn of the same set in the direction of travel of the piston of the cartridge under a braking action, and in that the driven turn of a set is able to form a mobile bearing means for the driving turn of the said set under a braking action.

Another subject of the present invention is a master cylinder, characterized in that the driving turn is separated from the driven turn by a distance that varies monotonously over one turn revolution.

Another subject of the present invention is a master cylinder, characterized in that the variation in the distance between the driven turn and the driving turn differs for each set.

Another subject of the present invention is a master cylinder, characterized in that the first spring is a helical spring with turns of roughly circular cross section and in that the second spring is a helical spring with turns of roughly parallelepipedal cross section.

Another subject of the present invention is a master cylinder, characterized in that the turns of the first spring are separated by a constant axial distance.

Another subject of the present invention is a master cylinder, characterized in that the turns of the second spring are separated by a constant axial distance.

Another subject of the present invention is a master cylinder, characterized in that the cartridge comprises means of adjusting the simulated pedal feel making it possible to alter the relative angular position of the driven turn with respect to the driving turn of the same set.

Another subject of the present invention is a master cylinder, characterized in that the said adjusting means comprise a stepping electric motor allowing the second spring to be moved rotationally.

Another subject of the present invention is an electro-hydraulic braking system comprising means of detecting the braking action of the driver, a computer receiving the information from the detection means and generating commands to actuate at least one brake arranged at a wheel, a pressure generator receiving the command from the computer to send pressurized fluid to the brakes, a master cylinder allowing the pedal feel to be simulated under normal operation and serving as a source of pressurized brake fluid in degraded operation, and electrically operated valves to interrupt the communication between the said master cylinder and the brakes in normal operation, characterized in that the said master cylinder is a master cylinder according to the invention.

Another subject of the present invention is a braking system, characterized in that the pressure generator is an electric pump.

The present invention will be better understood with the aid of the description which follows and of the appended drawings for which the front, the rear, the upper part and the lower part correspond respectively to the left, the right, the top and the bottom of the drawings and in which:

The same references will be used for elements which have substantially the same shape or substantially the same function.

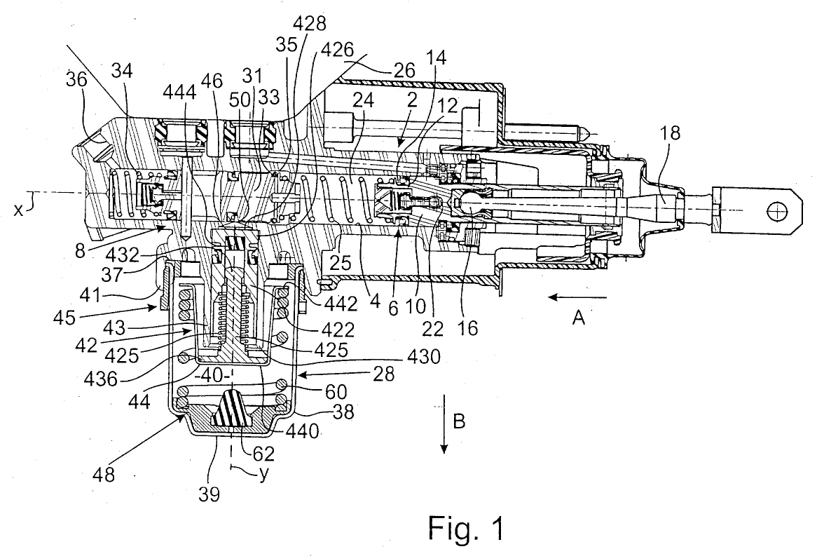

FIG. 1 is a view in longitudinal section of a master cylinder for an electro-hydraulic braking system of the state of the art;

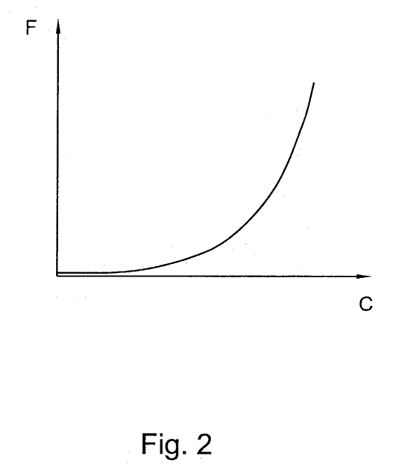

FIG. 2 is a characteristic curve of the pedal feel of a conventional hydraulic circuit;

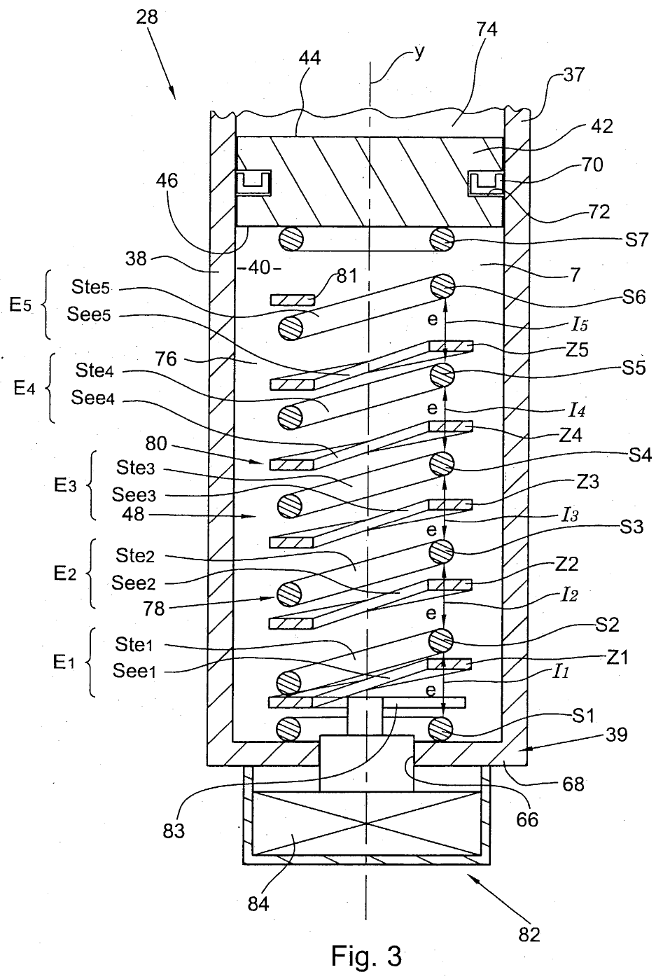

FIG. 3 is a sectioned view of a detail of a master cylinder according to the present invention.

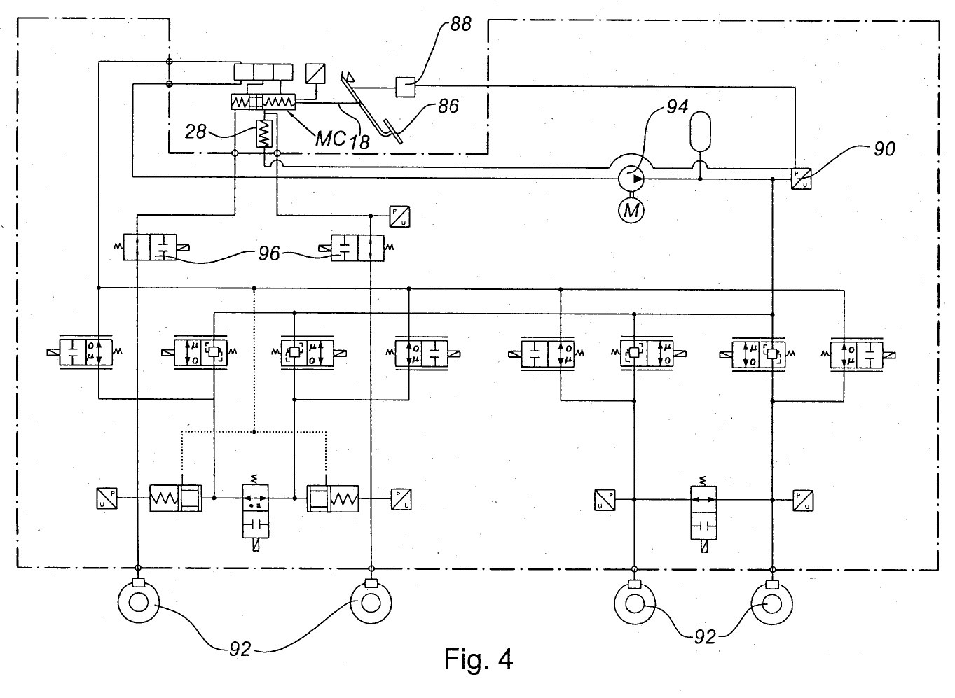

FIG. 4 is a diagram of an electro-hydraulic braking system according to the present invention.

FIG. 1 shows a master cylinder of known type comprising a body 2 of longitudinal axis X pierced with a bore 4 of axis X which is blind, divided into a primary hydraulic circuit 6 and a secondary hydraulic circuit 8. As the primary and secondary hydraulic circuits have similar structures, we shall describe only the primary circuit 6.

The primary circuit 6 comprises a hydraulic piston 10 mounted to slide in a sealed manner in the bore 4 by means of a lip seal 12 mounted in an annular groove 14 made on the periphery of the piston 10. In its rear part, the piston 10 houses a front longitudinal end 16 of an actuating rod 18 shaped as a ball, the actuating rod being connected by a longitudinal rear end 20 to a brake pedal (not depicted) placed in the cabin of the vehicle. The piston 10 divides the bore 4 into a supply chamber 22 arranged behind the piston 10 and a working chamber 24 in front of the piston 10. The supply chamber is connected by sealed means 24 to a brake fluid reservoir 26 and the working chamber is connected in normal operation to a cartridge simulating the pedal feel 28 and in degraded operation is connected to brakes at the wheels.

The piston 10 in its central part has a longitudinal passage 30 equipped with a valve 32 which, at rest, places the supply chamber and the working chamber in communication, and during a braking phase isolates the two chambers 22, 24.

A means 25 of returning the piston 10 is arranged in the primary working chamber 24.

Unlike the primary circuit 6, the secondary circuit is never connected hydraulically to the cartridge 28. Indeed in normal operation, the secondary working chamber 34 is isolated from the braking circuit and, in degraded operation, the secondary working chamber is connected to the brakes by a duct 36 which is open in the rest state and in the degraded state and connects the secondary working chamber 34 to the brakes. The secondary piston 31 comprises an O-ring seal 35 on its outer periphery, collaborating in degraded operation with a shoulder 33 made on the periphery of the bore 4 and interrupting communication between the working chamber 24 and the inside of the cartridge 28.

The cartridge simulating the pedal feel 28 of axis Y substantially perpendicular to the axis X of the body of the master cylinder comprises a substantially U-shaped envelope 38. The envelope has an open end 37 fixed in sealed manner to the body of the master cylinder and an end wall 39, and defines an interior chamber 40 in which there is sealedly and slideably mounted a piston 42 subjected, on a first face 44, to the pressure in the primary working chamber 24 and on a second face 46, the opposite of the first face 44, to the reaction of an elastic means 48.

Brake fluid from the working chamber 24 is conveyed to the cartridge via a duct 50 made in the body of the master cylinder substantially at right angles to the axis X.

The body of the master cylinder 2 comprises a first 43 and a second 41 sleeve which are coaxial of axis Y, the first sleeve 43 borders the duct 50 and houses such that it can slide in a sealed manner, part of the piston 42, the second sleeve 41 surrounds the first sleeve 43 and comprises means 45 for fixing the cartridge to the body of the master cylinder, for example a screw and nut 45.

The piston 42 is composite and comprises a first tubular part 422 sliding in sealed fashion in the first sleeve 43 by means of a lip seal arranged in a groove 424 made in the exterior periphery of the first part 422. The first tubular part 422 has a first longitudinal end 426 closed off by an end wall 428 facing the duct 50 and a second longitudinal end 430 opposite the first end 426, accommodating a second part 425 of the piston 42 in the shape of a T facing downwards, the base of the T 432 being slideably mounted in the first tubular part 422. A helical spring 434 is mounted in compression between the head 436 of the T 425 and a shoulder made in the first tubular part 422.

The piston 42 also has a third part 438 in the shape of a U facing upwards in the figure and surrounding the first sleeve 43, the bottom 440 of the U 438 housing the head 436 of the second part 425. The third part at its open upper end has a flange 442 extending radially outwards.

An elastic block 444, for example made of elastomer, is arranged between the closed end 428 of the first part 422 and the base of the T 432.

The elastic means 48 for simulating the pedal feel comprises the first helical spring 434 of constant pitch, a helical spring 60 of variable pitch mounted in compression between the closed end 39 of the envelope and the flange 442 and an elastomer peg 62 trapped between the bottom 39 of the cartridge and a lower longitudinal end 64 of the spring 60, the said peg simulating the feel of the reaction at the pedal during maximum braking at the end of travel for a conventional braking circuit.

During the braking action, the springs 434,60 work in their elastic deformation domain.

We shall now quickly describe the operation of the master cylinder of the prior art.

When the brake pedal is acted upon, the piston 10 moves in the direction indicated by the arrow A against the action of the spring 25 causing the valve 32 to close and isolating the chambers 22 and 24, the volume of the working chamber 24 reducing, the pressure increases in the working chamber acting on the first face 44 of the piston 42. When the pressure in the working chamber 24 exceeds a predetermined value, the piston 42 moves in the direction of the arrow B against the action of the spring 434 then of the spring 60.

First of all, the spring 434 is able to simulate the absorption of a conventional braking circuit, then because of the variability of the pitch of the spring 60, the relationship between the movement of the piston 42 and the pressure applied to the first face 44 of the piston 42 is not linear and is similar to the reaction of a conventional braking circuit (FIG. 2).

At the end of travel, corresponding to a maximum braking force, the piston crushes the peg 62 via the small base 54 and this simulates the saturation in a conventional braking circuit.

The piston of the secondary circuit does not move.

In degraded operation, the duct 36 of the secondary circuit is open and the movement of the primary piston 10 causes the secondary piston 31 to move and this closes the communication between the working chamber 24 and the cartridge 28 by applying the O-ring seal 35 against the shoulder 33. The master cylinder then behaves like a conventional master cylinder.

The master cylinder as described previously is satisfactory although it is complex in design and does not allow the reaction simulated by the cartridge to be altered.

There are also electro-hydraulic braking systems with a single-circuit master cylinder, that is to say one having just one pressure piston and therefore one working chamber connected in normal operation to the pedal feel cartridge and in the event of failure feeding two or four brakes of the wheels.

FIG. 3 shows a cartridge for simulating the pedal feel 28 according to the present invention. The master cylinder is identical to the one described previously, and we shall therefore describe only the cartridge 28.

The cartridge 28 according to the present invention has an envelope 38 of axis Y in substantially the shape of a U, the upper part of the U forming an open first longitudinal end 37 of the cartridge which is connected in a sealed manner to the body 2 of the master cylinder. A second longitudinal end opposite the first end 37 forming the end wall 39 of the cartridge is advantageously pierced with an orifice 66 flanked by a substantially annular flange 68 and allowing the passage of an adjusting means.

The envelope 38 defines an interior chamber 40 in which a piston 42 is mounted so that it can slide in a sealed manner, sealing being achieved for example by means of a lip seal 70 mounted fixedly in an annular groove 72 made on the periphery of the piston 42 facing the interior lateral surface of the chamber 40, the shape of the piston 42 not of course being limiting, and the use of a piston as depicted in FIG. 1 not departing from the scope of the present invention.

The piston 42 divides the chamber 40 in a sealed manner into an upper hydraulic chamber 74 delimited in part by a first face 44 of the piston 42 and into a “dry” lower chamber 76 delimited by a second face 46 of the piston 42, the chamber 76 being qualified as “dry” because, unlike the chamber 74, it does not receive any brake fluid.

The cartridge 28 also comprises an elastic means 48 mounted in the lower chamber 76, the elastic means comprising at least one helical spring 78 of axis Y mounted in compression between the second face 46 of the piston 42 and the annular flange 68.

The spring 78 according to the embodiment depicted is a helical spring of uniform pitch comprising turns S1, S2, S3, S4, S5, S6, S7, and therefore the spaces I1, I2, I3, I4, I5 separating the turns S1, S2, S3, S4, S5, S7 all have the same axial dimension e.

However, it is conceivable to provide, for example, a helical spring of variable pitch, a cylindrical or conical helical spring.

Obviously the spring 78 under a braking action works in its elastic-deformation domain.

The elastic means 48 also comprises a second helical spring comprising second turns Zi, in the example depicted it has Z1, Z2, Z3, Z4, Z5, Z6 and mounted coaxially with respect to the first spring 78 in the spring 78. The second spring 80 is then able to collaborate with the spring 78 in such a way that the second turns Z1, Z2, Z3, Z4, Z5, Z6 are arranged respectively in the spaces I1, I2, I3, I4, I5, I6.

i, j, n is a positive integer greater than unity.

The second spring 80 advantageously has a uniform pitch, and therefore in the embodiment depicted the spaces separating the turns of the second spring 80 are all of the same length d.

The distance d separating the turns of the second spring 80 is advantageously smaller than the distance e separating the turns of the first spring 78. However, a cartridge comprising a second spring having a pitch greater than that of the first spring does not constitute a departure from the scope of the present invention.

Thus, the elastic means 48 comprises sets Ej formed of a turn of the first turns Sn of the first spring 78, known as the driving turn Stej, and of a turn of the second turns Zi of the second spring, known as the driven turn Seej. The number of sets Ej is equal to the number of turns Zi of the second spring 80, minus 1.

As the distance aj separating the driven turn Seej from the driving turn Stej of a set Ej increases or decreases continuously over a turn revolution depending on the direction of rotation chosen, contact during a braking phase between the driving turn and the driven turn occurs progressively and therefore the passage of the elastic means 48 from one stiffness value to another value is also progressive and this reduces discontinuities in the pedal feel felt by the driver and allows a simulated circuit reaction very similar to the reactions of a conventional braking circuit.

In addition, the distance aj separating a driven turn Seej from a driving turn Stej from one set Ej to another does not vary in spaces of different lengths. In consequence, all the driving turns do not come into contact with their associated driven turn all at the same time, and this allows an almost continuous variation in the stiffness of the elastic means 48.

Of course, it is not necessary for the first and second springs 78, 80 to have the same number of turns Sn, Zi.

The second spring 80 has a free top end 81 and a bottom end 83 fixed either to a stopper plugging the orifice 66 once the elastic means 48 has been fitted or to means 82 of adjusting the simulated pedal feel.

The first spring is advantageously a helical spring the turns Sn of which have a circular cross section and the second spring is advantageously a spring with flat turns Zi, the turns Zi having a cross section of parallelepipedal section.

However, of course the first and second springs 78, 80 could both be wire or flat springs, cylindrical or conical or any other type of springs allowing the turns of the first spring 80 to bear against the turns Zi of the second spring.

Of course it is unnecessary for all the spaces In to contain a turn Zi of the second spring 80.

The first and second springs 78, 80 are advantageously made of metal spring wire although the use, for example, of plastics or any other material having the same properties as metal spring wire for one or both springs 78,80 is conceivable.

The embodiment as depicted also comprises means 82 of adjusting the simulated pedal feel, doing this by modifying the relative angular position of the second spring 80 with respect to the first spring 78, particularly the angular position of the driven turn Seej of one set Ej relative to the driving turn Stej of the said set Ej, this altering the spacing of variation of the distance a separating the driving turn Stej from the driven turn Seej of the same set Ej and thus modifying the characteristic of the force-at-pedal/pedal-travel relationship.

The adjusting means 82 comprises a device 84 making it possible to alter the angular position of the turns Z1, Z2, Z3, Z4, Z5, Z6 relative to the turns S1, S2, S3, S4, S5, S6, S7 and thus to alter the characteristic of the reaction at the brake pedal.

The device 84 is, for example, an electric stepping motor to which the second longitudinal end 39 of the second spring is fixed, the motor allowing the second spring 80 to be moved angularly clockwise or counterclockwise relative to the first spring 78.

We shall now describe the way in which the pedal feel simulation cartridge according to the present invention works. Of course, when we describe the coming of a turn Sn into contact with a turn Zn, this is progressive and continuous contact occurring in turn regions and not in whole turns all at once.

When the brake pedal is acted upon, the piston 10 moves in the direction of the arrow A against the spring 25 causing the valve 32 to close and isolating the chambers 22 and 24, as the volume of the working chamber 24 reduces, the pressure increases in the working chamber and also acts on the first face 44 of the hybrid piston 42. When the pressure in the working chamber 24 exceeds a predetermined value, the hybrid piston 42 moves in the direction of the arrow B against the spring 78.

If the pressure in the working chamber 24 continues to increase, the driven turn Seej of a set Ej, of which the maximum axial dimension aj separating the driving turn Stej and the driven turn Seej is the lowest relative to the minimum aj dimensions a of the other sets Ej, comes progressively and continuously to bear against the driven turn Seej and carries this in the direction B, altering the stiffness of the elastic means 48 and therefore the reaction at the pedal.

In the example depicted, it is the driving turn S2 or Ste1 of the set E1 which comes progressively into contact first with the driven turn Z1 or See1.

It is conceivable for there to be several driving turns Stej coming progressively into contact with their associated driven turn Seej simultaneously.

If the driver continues to move the brake pedal in the direction of an application of the brakes, the pressure in the working chamber 24 increases further and moves the piston 42, thus bringing other driving turns Stej to bear on their associated driven turns Seej and therefore altering the stiffness of the elastic means 48 again, increasing this stiffness.

This continues until the piston 48 comes to bear against the peg simulating the end of travel of a conventional braking circuit.

In consequence, the elastic means 48 forms an adjustable variable-pitch spring.

Of course, the axis Y of the cartridge can be oriented in any other way than at right angles to the axis X of the body of the master cylinder.

FIG. 4 shows an electro-hydraulic braking system according to the present invention, comprising a master cylinder MC according to the present invention actuated by the actuating rod 18 connected to a brake pedal 86, means 88 of detecting the longitudinal movement of the actuating rod 18, for example travel sensors, a computer 90 receiving information from the detection means 88 and generating commands to actuate the brakes 92, a pressure generator 94, for example an electric pump receiving the command from the computer 90 to send pressurized fluid to the brakes 92 and electrically operated valves 96 to interrupt the communication between the master cylinder and the brakes in normal operation, these valves being open at rest and in degraded operation.

When the driver acts upon the brake pedal 86, the detection means 88 send the information to the computer 90 which generates the command for the pump 94 to send pressurized fluid to the brakes 92. A simulated reaction corresponding to a conventional braking circuit is transmitted to the driver via the brake pedal, giving him the possibility of adjusting the strength of his braking.

Of course, a master cylinder having just one hydraulic circuit formed of one supply chamber and one pressure chamber, the pressure chamber being connected to a pedal feel simulation cartridge having an elastic means according to the present invention would not be departing from the scope of the present invention.

We have indeed produced a master cylinder comprising pedal feel simulating means which are effective and of simple design, and which advantageously allow these master cylinders to be adapted simply and quickly to suit various vehicle models, the technique and/or adapted to suit the desires of the driver of the vehicle.

The present invention applies in particular to the motor industry.

The present invention applies in particular to the motor vehicle braking industry, particularly the braking industry aimed at private cars.

1. Master cylinder for electro-hydraulic braking systems comprising a body (2) of longitudinal axis (X) pierced with a bore (4), a piston (10) mounted to slide in sealed fashion in the bore and axially dividing the bore into a supply chamber (22) sealedly connected to a brake fluid reservoir (R) and a working chamber (24) and a cartridge (28) simulating the pedal feel, the said working chamber (24) in normal operation being in communication with the inside of the cartridge (28) simulating the pedal feel and in degraded operation being in communication with at least one brake arranged at a wheel, the said cartridge (28) comprising a piston (42) able to be subjected, via a first face (44) to the pressurized brake fluid supplied by the working chamber (22) and subjected via a second face (46) to a variable-stiffness elastic means (48), characterized in that the elastic means (48) comprises at least a first helical spring (78) and a second helical spring (80), the first spring (78) having first turns (Sn) and being mounted so as to bear between the second face (44) of the piston (42) of the cartridge and an end wall of the cartridge, the second spring (80) having second turns (Zi) and being mounted coaxial with the first spring (78) so that the elastic means (48) comprises sets (Ej) formed of a driving turn (Ste) of the first spring (78) and of a driven turn (Seej) of the second spring (80), the driving turn (Stej) preceding the driven turn (Seej) of the same set (Ej) in the direction (B) of travel of the piston (42) of the cartridge under a braking action, and in that the driven turn (Seej) of a set (Ej) is able to form a mobile bearing means for the driving turn (Stej) of the said set under a braking action.

2. Master cylinder according to claim 1, characterized in that the driving turn (Stej) is separated from the driven turn (Seej) by a distance (aj) that varies monotonously over one turn revolution.

3. Master cylinder according to claim 2, characterized in that the variation in the distance (aj) between the driven turn (Seej) and the driving turn (Stej) differs for each set (Ej).

4. Master cylinder according to claim 1, 2 or 3, characterized in that the first spring (78) is a helical spring with turns (Sn) of roughly circular cross section and in that the second spring (80) is a helical spring with turns (Zi) of roughly parallelepipedal cross section.

5. Master cylinder according to claim 1 to 4, characterized in that the turns (Sn) of the first spring (78) are separated by a constant axial dimension (e).

6. Master cylinder according to any one of the preceding claims, characterized in that the turns (Zi) of the second spring (78) are separated by a constant axial distance (d).

7. Master cylinder according to any one of the preceding claims, characterized in that the cartridge comprises means (82) of adjusting the simulated pedal feel making it possible to alter the relative angular position of the driven turn (Seej) with respect to the driving turn (Stej) of the same set.

8. Master cylinder according to the preceding claim, characterized in that the said adjusting means (82) comprise a stepping electric motor allowing the second spring to be moved rotationally.

9. Electro-hydraulic braking system comprising means 88 of detecting the braking action of the driver, a computer 90 receiving the information from the detection means 88 and generating commands to actuate at least one brake 92 arranged at a wheel, a pressure generator 94 receiving the command from the computer 90 to send pressurized fluid to the brakes 92, a master cylinder allowing the pedal feel to be simulated under normal operation and serving as a source of pressurized brake fluid in degraded operation, and electrically operated valves 96 to interrupt the communication between the said master cylinder and the brakes in normal operation, characterized in that the said master cylinder is a master cylinder according to any one of the preceding claims.

10. Braking system according to the preceding claim, characterized in that the pressure generator (94) is an electric pump.
